(19) United States
(12) Patent Application Publication
(10) Pub. No.: US 2012/0062719 A1
(43) Pub. Date: Mar. 15, 2012

(54) Head-Mounted Photometric Facial Performance Capture

(75) Inventors: PAUL E. DEBEVEC, Marina del Rey, CA (US); ANDREW JONES, Playa Del Rey, CA (US); GRAHAM LESLIE FYFFE, Los Angeles, CA (US); WAN-CHUN MA, Taipei (TW); XUEMING YU, Arcadia, CA (US); JAY BUSCH, Lawndale, CA (US)

(73) Assignee: UNIVERSITY OF SOUTHERN CALIFORNIA, Los Angeles, CA (US)

(21) Appl. No.: 13/229,370

(22) Filed: Sep. 9, 2011

Related U.S. Application Data
(60) Provisional application No. 61/403,013, filed on Sep. 9, 2010.

(51) Int. Cl. H04N 5/225

(52) U.S. Cl. 348/77; 348/E05.024

(57) ABSTRACT

A camera may capture a sequence of images of a face while the face changes. A camera support may cause the field of view of the camera to remain substantially fixed with respect to the face, notwithstanding movement of the head. A lighting system may light the face from multiple directions. A lighting system support may cause each of the directions of the light from the lighting system to remain substantially fixed with respect to the face, notwithstanding movement of the head. Sequential images of the face may be computed as it changes based on the captured images. Each computed image may include least per-pixel surface normals of the face that are calculated based on multiple, separate images of the face. Each separate image may be representative of the face being lit by the lighting system from a different one of the separate directions.

### CROSS-REFERENCE TO RELATED APPLICATION

This application is based upon and claims priority to U.S. provisional patent application 61/403,013, entitled “HEAD-MOUNTED PHOTOMETRIC FACIAL PERFORMANCE CAPTURE SYSTEM,” filed Sep. 9, 2010, attorney docket number 028080-0606. The entire content of this application is incorporated herein by reference.

### STATEMENT REGARDING FEDERALLY SPONSORED RESEARCH

This invention was made with Government support under Contract No. W911NF-04-D-0005, awarded by the Army Research Institute. The Government has certain rights in the invention.

### BACKGROUND

1. Technical Field

This disclosure relates to facial performance capture, head-mounted cameras, and animation.

2. Description of Related Art

### Overview

Head-mounted cameras can be an important tool for capturing facial performances to drive virtual characters. They can provide a fixed, unoccluded view of the face. This can be useful for observing motion capture dots or as input to video analysis. However, the 2D imagery captured with these systems may be affected by ambient light and may fail to record subtle 3D shape changes as the face performs.

### BACKGROUND

Realistic facial animation can be a major challenge in computer graphics as human brains are wired to detect many different attributes of facial identity, expression, and motion. Advances in 3D scanning have enabled rapid capture of high-quality dense facial geometric and reflectance models that match real human subjects. This has led to many examples of compelling static virtual faces. The problem complexity, however, can dramatically increase for believable facial motion. Dynamic 3D scanning techniques can require specialized cameras and projectors aimed at the face. The fixed hardware defines a limited capture volume so the subject's head may need to remain relatively stationary throughout the performance. Yet, facial animation may not exist in a vacuum. Facial actions can be accompanied by full body actions. For example, eye gaze can follow the larger motion of the neck and torso and dialog can be accompanied by multiple hand gestures.

An alternative approach is to capture only sparse motion points using marker-based motion capture. Motion capture stages can accommodate multiple full-body performances and can scale up with additional cameras. Marker-based systems may work well for bodies as markers can be placed at key joints to capture most degrees of freedom. Unfortunately, faces may exhibit a significantly wider range of deformation that may not easily be represented by a simple set of bones and joints. This may require a dedicated set of up to 100 markers. Even then, important details around the mouth and eyes may not be captured where it may not be possible to place dense markers.

Recently, commercial productions have started to use head-mounted cameras in motion capture environments to more accurately record dense sets of facial motion capture markers. These cameras may provide a fixed video of the face, even as the actor moves through a larger capture volume.

### Passive Capture

A single video camera may record a facial performance. In the absence of 3D cues, prior facial models, such as 2D active appearance models or 3D morphable models, can be used to constrain the recovered motion parameters. The quality of the recovered motion, however, may be highly dependent on the training database. Generalized facial models trained on a large set of subject are capable of accurately categorizing emotions, but may miss fine details and motions unique to a specific subject.

Active appearance models were used on James Cameron's film “Avatar” to recover some eye motion from head-mounted camera data. Head-mounted cameras have also been used with the proprietary facial analysis software developed by the company Imagemetrics. Unfortunately, video from a head-mounted camera may be characterized by sudden changes in illumination as the actor moves through the capture stage or rotates her head. Automated computer vision algorithms may have difficulty distinguishing changes in facial expression from changes in this illumination. Both rigs used by Imagemetrics and for “Avatar” may be affected by moving ambient light, despite using a visible LED as a fixed illumination source.

### Stereo Capture

Additional stereo cameras can be utilized to recover 3D geometry. Commercially, a head mounted rig with four small high-definition cameras was developed by the company Imagemovers and first used on Robert Zemeckis's film “A Christmas Carol”. For dynamic performances, stereo can be extended to multi-camera optical flow for tracking facial motion. A single-shot technique may be used to create high quality geometry using high resolution stereo cameras and a displacement map based on ambient shadowing of skin pores.

As with passive techniques, stereo matching and optical flow may rely on the natural texture of face, such as skin pores, to find corresponding points between photographs. While a face may exhibit a wide range of geometric and texture detail at multiple scales, many of these features may not be visible under ambient illumination. In areas with insufficient texture, stereo and optical flow techniques may rely on regularization which may result in a loss of surface detail. Additional surface detail may be created by the application of skin makeup. Colored makeup and shape from shading may be used to recover specific areas of wrinkling. Fluorescent makeup and ultraviolet illumination may be used to generate dense randomized facial texture. Applied makeup can be also seen as a form of motion capture marker.

### Marker-Based Capture

Marker-based motion capture may be used for full-body and facial performance capture. Many different types of markers exist including passive retro-reflective markers, coded LEDs, and accelerometers. As camera technology increases in speed and resolution, systems can identify denser data sets with more and smaller markers. While sparse points provide useful information about the large-scale shape of the face, they may miss several critical regions, such as fine-scale skin wrinkling, complex mouth contours, eye contours, and eye gaze. Significant effort from animators may be needed to manually recreate this missing motion detail. To remain faithful to the original performance, these artists may rely on additional reference cameras, including head-mounted cameras.

One of the first head-mounted cameras for facial performance capture was used on Robert Zemeckis's film “Beowulf”. The camera was combined with electro-ocularography sensors that attempted to directly record nerve signals for eye muscles. Unfortunately the recorded signals may be noisy and unreliable and may not be useable without additional cleanup.

### Structured-Light Capture

Active illumination approaches can recover geometric information without relying on natural features. Structured light capture techniques may correspond camera and projector pixels by projecting spatially varying light onto the face. Depth accuracy may be limited by the resolution of the camera and projector. Different sets of illumination patterns have been optimized for processing time or accuracy. At one extreme, a single-shot noise pattern may be used with traditional stereo algorithms. An example of this is the Kinect controller for the Xbox game system which uses a hard-coded matching algorithm to achieve real-time depth, but with limited accuracy. Alternatively, a large set of sequential patterns may be used to fully encode projector pixel location. During a dynamic performance, there may be significant motion between subsequent illumination frames. Motion artifacts may be handled by either reducing the number of projected patterns or explicitly shifting the matching window across time.

### Dynamic Photometric Stereo

Another form of active illumination is photometric stereo. Traditional photometric stereo uses multiple point lights to recover surface orientation (normals) by solving simple linear equations. Unlike stereo and structured light techniques which recover absolute depth, surface orientation may be equivalent to directly measuring the depth derivative. As a result, photometric stereo may provide accurate local high frequency information, but may be prone to low-frequency errors. Photometric stereo may also have the advantage that it can be computed in real-time on standard graphics hardware. As with structured light, it is desirable to reduce the total number of photographs. A single shot approach has been suggested where the different illumination directions are encoded in the red, green, and blue color channels. A drawback of this approach is that it may assume constant surface color. This idea has been extended using optical flow, white makeup, better calibration, or additional spectral color channels. Photometric stereo has been formulated using four spherical gradients to minimize shadows and capture normals for the entire face. This has been used for dynamic facial performance capture, but may require a large lighting apparatus.

### SUMMARY

A photometric facial performance capture system may include a camera, a camera support, a lighting system, a lighting system support, and a data processing system. The camera may be configured to capture a sequence of images of a real face that is part of a head of a person while the face changes. The camera support may be configured to cause the field of view of the camera to remain substantially fixed with respect to the face, notwithstanding movement of the head. The lighting system may be configured to light the face from multiple directions. The lighting system support may be configured to cause each of the directions of the light from the lighting system to remain substantially fixed with respect to the face, notwithstanding movement of the head. The data processing system may be configured to compute sequential images of the face as it changes based on the captured images. Each computed image may be expressed in the form of per-pixel surface normals of the face that are calculated based on multiple, separate images of the face. Each separate computed image may be representative of the face being lit by the lighting system from a different one of the separate directions.

The photometric facial performance capture system may include a light controller configured to cause the lighting system to sequentially light the face from each of the multiple directions. The camera may be configured to capture the captured images at capture moments. The light controller may be configured to cause the sequential changes in the lighting system to be synchronized with the capture moments. The per-pixel surface normals of each of the computed images may be based on a multiplicity of the captured images, such as three or four. One of each of the sequential captured images may be captured when the face is not lit by the lighting system. The data processing system may be configured to compensate for lighting of the face by sources other than the lighting system based on the images that are captured by the camera when the face is not lit by the lighting system.

The data processing system may be configured to compensate for changes in the face that take place between the multiplicity of captured images when determining the per-pixel surface normals for each of the computed images.

The light controller may be configured to cause the lighting system to sequentially light the face from each of the multiple directions at a rate that is an integer-greater-than-one multiple of the rate at which the camera captures the sequence of images of the face.

The lighting system may be configured to light the face from each of the multiple directions with only a single light source.

The lighting system may be configured to light the face from each of the multiple directions with multiple, spaced-apart light sources.

The lighting system may be configured to simultaneously light the face from each of the multiple directions with light of a different color. Each of the separate images on which the per-pixel surface normals of each of the computed images are based may be a version of one of the captured images filtered by a different one of the different colors.

The lighting system may be configured to light the face from the multiple directions with infrared light.

The lighting system may be configured to light the face with spatially varying illumination such as in the form of noise, striped, sinusoidal, or gradient patterns.

The lighting system may be configured to light the face from the multiple directions with polarized light, such as linearly or circularly polarized light. A polarizer may be configured to polarize the images captured by the camera with a polarization that filters the specularly reflected light. For example, orthogonal linear polarizers may attenuate the specularity reflected light from the face, as might circular polarizers of opposite chirality.

The photometric facial performance capture system may include one or more mirrors configured to direct the sequence of image of the face while it changes to the field of view of the camera. The mirrors may be flat, or concave or convex to allow the camera to better see a greater portion of the face in a reflected view. Multiple mirrors, or a mirror with a curved surface, may be placed in the field of view of one camera to allow the camera to record the face as seen from multiple viewpoints simultaneously. The inclusion of mirrors may allow the camera or cameras to be mounted closer to the center of the head to allow the actor to move their head more easily.

The camera, the camera support, the lighting system, and the lighting system support may be part of an apparatus configured to mount on the head.

A facial animation generation system may generate facial animation. The system may include a photometric facial performance capture system configured to capture a sequence of images of a real face while the face changes and to compute images of the face as it changes based on the captured images. Each computed image may be expressed in the form of per-pixel surface normals of the face. A photometric shape driven animation system may be configured to generate a facial animation based on the data, including the per-pixel surface normals.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a photometric facial performance capture system.

FIG. 2 illustrates an example of components of the photometric facial performance capture system illustrated in FIG. 1 mounted on a human head.

FIG. 3 illustrates components of the photometric facial performance capture system illustrated in FIG. 1 mounted on a human head in an arrangement that utilizes a mirror.

FIG. 4 illustrates illumination of a single source of light in the lighting system illustrated in FIG. 2.

FIGS. 5A-D illustrate images of a face that were captured by a camera under different lighting conditions. FIGS. 5A-C illustrate images lit by lighting from different directions from a lighting system of the type illustrated in FIG. 2. FIG. 5D illustrates images lit by only background light, with no light coming from the lighting system.

FIG. 6 illustrates illumination of several lights sources in the lighting system illustrated in FIG. 2 with a gradient of intensities.

FIG. 7 illustrates a different example of the lighting system illustrated in FIG. 2 in which light from each direction is generated by clusters of light sources.

FIG. 8A illustrates a face being lit by a visible light gradient, while FIG. 8B illustrates a face being lit by an infrared light gradient.

FIG. 9 illustrates an example of smoothed template geometry that may be used to initialize relative lighting directions and depth.

FIG. 10 illustrates an example of multiple light pathways from the face to the camera.

FIGS. 11A-C illustrate sample results from the data processing system illustrated in FIG. 1 for a dynamic facial sequence using three illumination directions.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

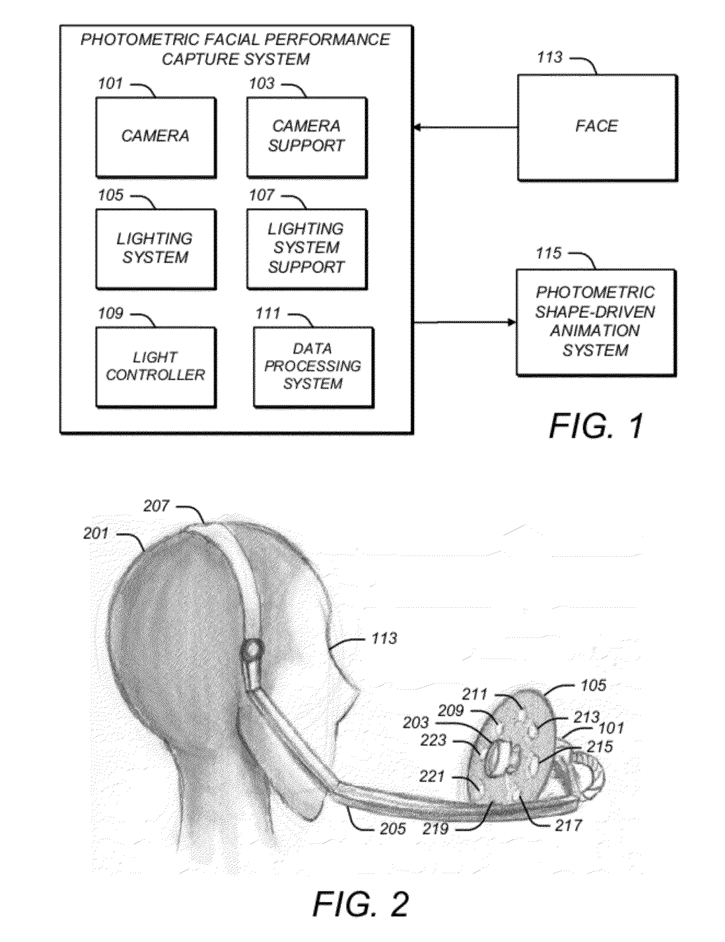

FIG. 1 illustrates an example of a photometric facial performance capture system. FIG. 2 illustrates an example of components of the photometric facial performance capture system illustrated in FIG. 1 mounted on a human head.

As illustrated in FIG. 1, the photometric facial performance capture system may include a camera 101, a camera support 103, a lighting system 105, a lighting system support 107, a light controller 109, and a data processing system 111. The photometric facial performance capture system may include additional or different components.

The camera 101 may be configured to capture a sequence of images of a face 113 that is part of a head 201 of a person while the face 113 changes, such as due to eye movement, lip movement, and/or changes in facial expressions.

The camera 101 may be of any type and may include a lens 203. For example, the camera 101 may be a Point Grey Grasshopper Camera capable of VGA resolution video at 120 fps while weighing only about 100 grams. Cameras such as the Point Grey Flea 3 and Basler Ace may achieve high-definition video in an even smaller form-factor, approximately the size of an ice cube.

The may be one or more cameras in addition to the camera 101 that capture additional views of the face. These views may be used to by the data processing system 111 to reduce occlusions where parts of the face are not visible, triangulate surface locations to recover the three-dimensional shape of face 113, and/or track facial features to recover facial animation parameters. One or more mirrors, lenses, and/or other optical devices may also be used to direct images from multiple directions to a single camera, thereby enabling the capture of images from multiple directions by a single camera. Filtering or gating may be needed to differentiate these various views.

The video images from the camera 101 may be delivered to the data processing system 111 by any means. For example, the video information may be delivered by a wired or wireless connection. The video images may instead be stored in a computer data storage device (not shown) and processed by the data processing system 111 at a later time. The video images from the camera 101 may or may not be in a compressed form.

The camera 101 may be configured to detect visible and/or infrared light.

The lens 203 of the camera may or may not include a light polarizer.

The camera support 103 may be configured to cause the field of view of the camera 101 to remain substantially fixed with respect to the face 113, notwithstanding movement of the head 201. The camera support 103 may be configured to cause the face 113 to mostly fill and be approximately within the center of the field of view of the camera 101. The camera support 103 may include an arm 205 attached at one end to the camera 101 and configured at the other end to be mounted to the head 201, such as through the use of a headband 207. A helmet or other type of structure may be used to fixedly attach the arm 205 to the head 201 instead lieu of the headband 207.

The head-mounted camera 101 may be subject to vibration during rapid motion of the subject. Additional tracking markers can be placed on the arm 205 and headband 207 to record its motion and stabilize the video relative to the face 113. To stabilize the face, the image may be warped using either a two-dimensional or three-dimensional transform so that the markers remain stationary within the frame.

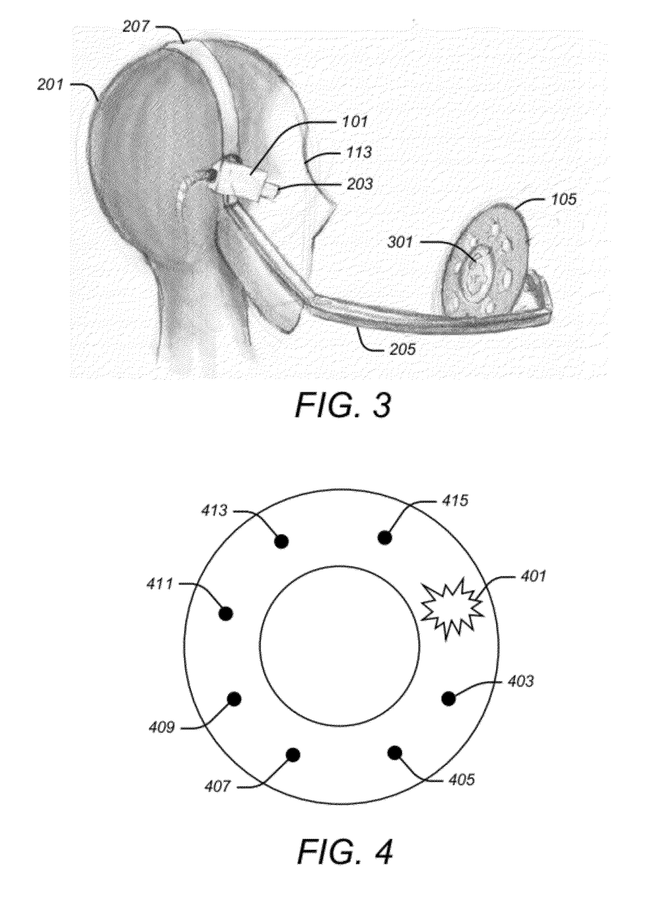

In an alternate configuration, the camera support 103 may be configured to cause the field of view of the camera 101 to focus on a mirror that reflects images of the face 113. FIG. 3 illustrates components of the photometric facial performance capture system illustrated in FIG. 1 mounted on a human head in an arrangement that utilizes a mirror 301. As illustrated in FIG. 3, the mirror 301 may be mounted at an end of the support arm 205 and oriented so as to reflect images from the face 113 to the lens 203 of the camera 101. The camera 101 may be mounted on the headband 207 that is affixed to the head 201. Its associated lens 203 may be configured to cause the field of view of the camera 101 to be substantially filled by the images of the face that are reflected by a mirror 301. The mirror 301 may be a flat mirror, a convex mirror, or a concave mirror, as may be best suited to causing the field of view of the camera 101 to be substantially filled by the images of the face 113.

The system may use multiple mirrors 301 mounted on the support arm 305 to reflect additional views of the face 113 to a single camera 101. This configuration may allow stereo images of the face to be captured without the additional weight caused by multiple cameras.

The lighting system 105 may be configured to light the face 113 from multiple directions. As illustrated in FIG. 2, the lighting system 105 may include multiple, spaced-apart light sources, such as light sources 209, 211, 213, 215, 217, 219, 221, and 223.

The multiple light sources may be in any arrangement. For example, the multiple light sources may be in a circular arrangement, as illustrated in FIG. 2. They may instead be arranged in a rectangular, triangular, or other pattern which may or may not be symmetrical. Although being illustrated as all within the same plane, the light sources may instead be in different planes.

The individual light sources may be of any type. For example, they may be LED's, incandescent bulbs, or pixels of a video projector. Although not illustrated in FIG. 2, a lens may be positioned between each light source or between all of the light sources and the face 113 so as to focus the light emanating from each light source on the face.

Each of the light sources may emit light of the same color or of the same mixed colors, such as white light. Each of the light sources may instead emit light of a different color, such as a different primary color, such as red, green, or blue. One or more of the light sources may instead be configured to emit infrared light.

One or more video projectors may be used as the lighting system 105. Examples are the latest DLP-based Pico projectors from Texas Instruments that are capable of frame rates above 120 Hz and weighs 1.7 gm using an LED light source. Multiple video projectors may be placed at different locations around the head, or individual parts of a projected frame could be reflected and redirect to illuminate the face from different directions.

A polarizer may be placed in front of each or all of the light sources so as to polarize the light that they cast upon the face. The polarization, for example, may be linear or circular. When a corresponding polarizer is used as a filter on the lens 203 of the camera 101, the polarizer may be configured to polarize the images captured by the camera with a polarization that filters the specularly reflected light. For example, orthogonal linear polarizers may attenuate the specularity reflected light from the face, as might circular polarizers of opposite chirality.

The lighting system support 107 may be configured to cause each of the directions of the light from the lighting system 105 to remain substantially fixed with respect to the face, notwithstanding movement of the head. The same apparatus as was discussed above in connection with the camera support 103 may be used to facilitate this, as illustrated in FIG. 2. In other configurations, the lighting system support 107 may be separate from the camera support 103.

The light controller 109 may be configured to control illumination of each of the light sources that comprise the lighting system 105. The light controller 109 may include electronic circuitry configured to perform the functions of the light controller 109, as described herein. This electronic circuitry may include a computer programmed with software that causes the computer to implement the lighting algorithms described herein.

In one configuration, the light controller 109 may be configured to cause the lighting system 105 to sequentially light the face 113 from each of the multiple directions. The light controller 109 may be configured to cause the light from each direction to be generated by illuminating a single light source or by illuminating multiple light sources.

FIG. 4 illustrates illumination of a single source of light in the lighting system illustrated in FIG. 2. As illustrated in FIG. 4, a light source 401 is illuminated, while all of the other light sources 403, 405, 407, 409, 411, 413, and 415 are dark. The light controller 109 may be configured to sequentially illuminate each of the different light sources illustrated in FIG. 4 or only some of them. FIG. 4 is thus illustrative of a configuration in which the light controller 109 is configured to sequentially illuminate a different single light source, thus causing the lighting system 105 to sequentially provide illumination from different directions.

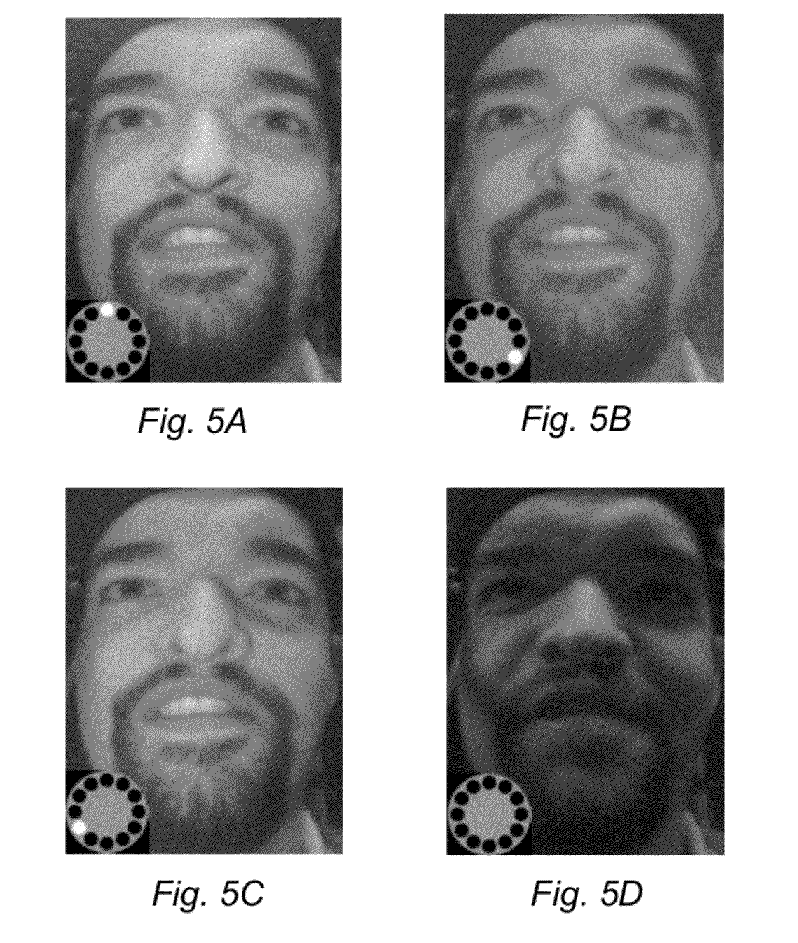

FIGS. 5A-D illustrate images of a face captured by the camera 101 under different lighting conditions. FIGS. 5A-C illustrates images lit from different directions from a lighting system of the type illustrated in FIG. 2. FIG. 5D illustrates image lit by only background light, with no light coming from the lighting system.

As illustrated in FIGS. 5A-D, the camera 101 may be configured to capture an image of the face while illuminated under the light coming from each of the separate directions, as well as an image of the face when it is not illuminated by the lighting system 105 at all, but rather only by background light. An example of how these images may be processed is described below in connection with the discussion of the data processing system 111. The light controller 109 may be configured to cause the lighting system 105 to provide this sequence of lighting.

The light controller 109 may instead be configured to simultaneously illuminate several or even all of the light sources that comprise the lighting system 105, but with different intensities. The illumination may create a gradient of light intensities that collectively combine to form a single light source that predominantly comes from a particular direction. The direction from which the predominate portion of this light source comes is referred to herein simply as the direction of the light source,

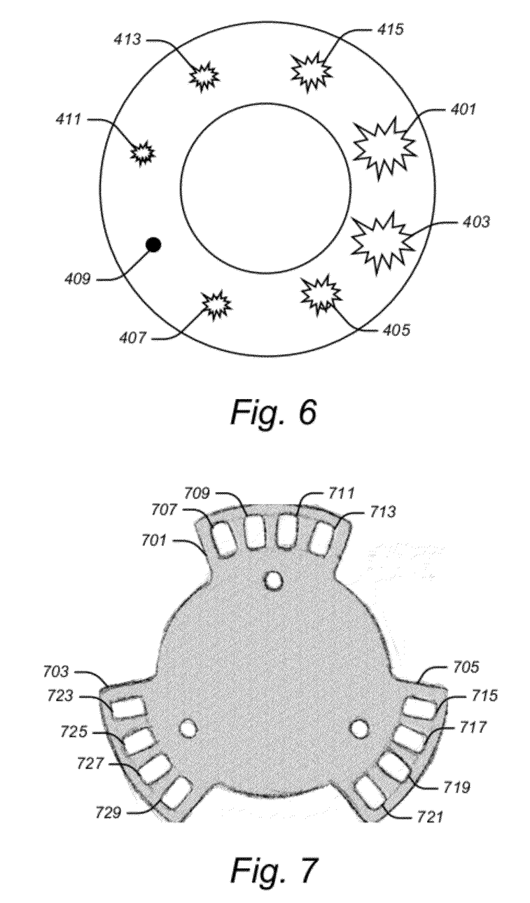

FIG. 6 illustrates illumination of several lights sources in the lighting system illustrated in FIG. 2 with a gradient of intensities. As illustrated in FIG. 6, the light controller 109 has caused all of the light sources in the lighting system 105 to be illuminated, except for the light source 409. The illuminated light sources have been illuminated in a gradient pattern. The light controller 109 may be configured to change the effective direction from which this gradient illumination is provided by rotating the gradient illumination pattern about the central axis of the individual light sources in discrete steps, each step causing the gradient illumination pattern to effectively come from a different direction.

FIG. 7 illustrates a different example of the lighting system illustrated in FIG. 2 in which light from each direction is generated by clusters of light sources. As illustrated in FIG. 7, the light sources that comprise the lighting system 105 may be arranged clusters, such as light source clusters 701, 703, and 705. Each cluster of light sources may include multiple light sources, such as light sources 707, 709, 711, and 713 for light source cluster 701; light sources 715, 717, 719, and 721 for light source cluster 705; and light sources 723, 725, 727, and 729 for light source cluster 703. The light source controller 109 may be configured to sequentially illuminate all of the light sources in each cluster of light sources, thus again sequentially causing light to originate from the lighting system 105 from different directions.

The light controller 109 may be configured to cause the sequential changes that it makes to the illumination of the light sources that comprise the lighting system 105 to be synchronized to when the camera 109 captures each image of the face 113. The camera 101 may be configured to generate a sync signal that is delivered and processed by the light controller 109 for this purpose. The sync signal may coincide with the moment when the camera 101 captures each image of the face 113. The light controller 109 may be configured to cause the direction from which light is emitted by the lighting system 105 to change in between each image of the face 113 which the camera 101 captures utilizing these sync signals. The light controller 109 may be configured to cause this pattern of lighting from different directions to cyclically repeat on a periodic basis. Within each cycle, the light controller 109 may be configured to completely shut off the lighting system 105 during one of the images that are captured by the camera 101. This may allow the camera 101 to capture an image of the face 113 during each cycle without any illumination from the lighting system 105. During each cycle, there may be two captured images, three captured images, four captured images, or more. The light controller 109 may be configured to cause one of the images to be captured at a time when no light is emitted by the lighting system 105.

The light controller 109 may be configured to cause the lighting system 105 to sequentially light the face from each of the multiple directions at a rate that is an integer-greater-than-one multiple of the rate at which the camera 101 captures the sequence of images of the face 113. The integer-greater-than-one may be two, five, ten, or any other integer greater than one.

The light controller 109 may instead be configured to cause all of the light sources in the lighting system 105 to be constantly illuminated while the camera 101 captures all of the images. This configuration may be useful when the lighting system 105 illuminates the face from each of the multiple directions with light of a different color.

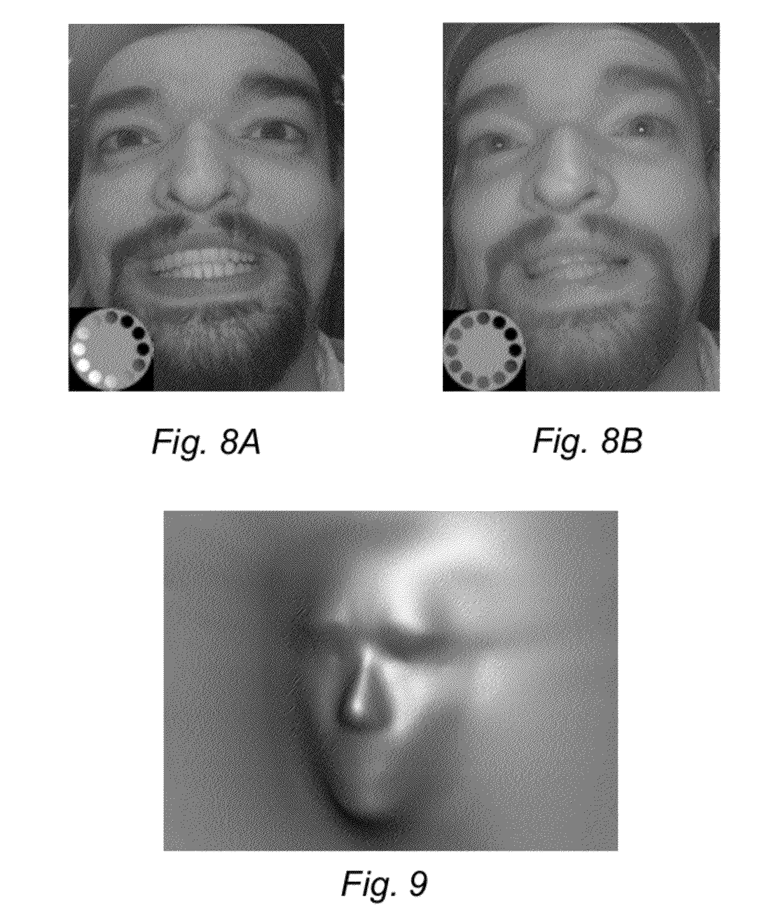

As indicated above, the lighting system 105 may be configured to illuminate the light with infrared light, rather than visible light. FIG. 8A illustrates a face being lit by a visible light gradient, while FIG. 8B illustrates a face being lit by an infrared light gradient. Using infrared light may be less distracting to the actor, as it may not be visible to the human eye.

The data processing system 111 may include electronic circuitry that is configured to cause the data processing system 105 to perform the functions described herein. The electronic circuitry may include a computer programmed with software that implements the processing algorithms described here.

The data processing system 111 may be attached to the camera support 103 and/or the lighting system support 107 or may be separate from it. The data processing system 111 may be configured to perform all or part of its data processing functions in real time, as the images are captured by the camera 101. These images from the camera 101 may instead be stored and processed later by the data processing system 111.

The data processing system 111 may be configured to compute sequential images of the face as it changes based on the images captured by the camera 101. Each computed image may be expressed in the form of per-pixel surface normals of the face. A per-pixel surface normal defines the direction of a line perpendicular to the surface that contains the pixel at the location of the pixel. It may be expressed as a three-dimensional unit vector. A per-pixel surface normal defines the direction of a line perpendicular to the surface that is imaged by a specific camera pixel. It may be expressed as a three-dimensional unit vector. Per-pixel surface normals of a face constitute a set of per-pixel surface normals that collectively span all the locations on the face seen by the camera.

The per-pixel surface normals of the face that are included in each image of the face may be calculated based on multiple, separate images of the face. Each separate image may be representative of the face being lit by the lighting system from a different one of the separate directions.

As explained above, the face may be lit by the lighting system 105 from each of the different directions sequentially as part of a cycle of different illuminations. In this situation, the data processing system 111 may be configured to generate a single image of the face based on each cycle of multiple images that are captured by the camera 101, such as based on two, three, four, or even more captured images. Each image is an image of the face being illuminated from a different direction by the lighting system 105.

As also explained above, one of the images in each cycle may instead be an image of the face when not lit by the lighting system 105 from any direction, but rather when lit solely by ambient light. In this configuration, the data processing system 111 may be configured to subtract the image taken under only ambient light from each of the other images that are captured under light from the lighting system 105 from one of the directions, thus eliminating the effect of ambient light in the computer image computations.

When colored lights are simultaneous directed to the face 113 from different directions by the lighting system 105, each image that is generated by the data processing system 111 may be based on only a single image that is captured by the camera 101. In this configuration, the data processing system 111 may separate the multiple color channels provided by the camera 101 based on each of the colors that are used in the lighting system 105, thus providing a separate image of the face 113 when lit from each of the different directions by the lighting system 105 base only on a single captured image.

When sequential captured images are used by the data processing system 111 to generate each generated image, the face may move between each captured image during a cycle of captured images. The data processing system 111 may be configured to compensate for these changes in the face that take place between captured images during the same cycle when determining the per-pixel surface normals for each of the computed images. For example, the data processing system 111 may be configured to warp each subsequent captured image in the cycle by the amount of movement that the face undergoes since the prior captured image. The warped images may therefore appear as if they were captured at the same moment. In lieu of detecting the movement that the face undergoes between each captured frame in a cycle, the data processing system 111 may be configured to only determine the degree of facial movement that takes place between the first of each captured image in each cycle and to linearly extrapolate this amount across the remaining captured images in each cycle.

The data processing system 111 may utilize any algorithm to determine the movement between captured images. For example, the data processing system 111 may perform an optical flow search which may find the best match between frames while enforcing a smoothness constraint that makes sure neighboring pixels have a similar motion

The data processing system 111 may implement any type of algorithm to compute the per-pixel normals of each computed image based on the captured images. Examples of such algorithms are now described in connection with sequential captured images, each under lighting from the lighting system 105 from a different direction. The same approaches could be used in connection with captured image of the face being simultaneous lit by the lighting system 105 from different directions by different colored lights, after the image of the face due to light from each directions is separated out from this single image, as explained above in connection with this lighting approach.

As presented in R. Woodham, Photometric method for determining surface orientation from multiple images, Optical Engineering, 19(1):139-144, 1980, photometric stereo may estimate surface orientation (normals) by analyzing how a surface reflects light incident from multiple directions. For lambertian reflectance, image intensity (I) can be expressed as the dot product of the lighting direction (L) and surface normal (N) scaled by the albedo (A) for each pixel in the image.

I=L·NA (1)

Given three observations of a pixel, each under a different corresponding lighting direction, equation (1) can be solved by inverting the 3×3 matrix of known lighting directions. After multiplying the inverted matrix by the observed pixel values, the resulting vector's length is the surface albedo and the normalized vector is the estimated surface normal.

During a performance, the per-pixel lighting directions and motion-compensated images may be converted to surface normals using Equation (1) above. This system of equations (1) may be solved on a computers central processing unit (CPU) and/or graphics processing unit (GPU) using common vector math functions. The matrix inverse may be computed for each pixel and the recovered 3 dimensional X/Y/Z surface normal may be stored and visualized as a Red/Green/Blue pixel color. Using modern computer hardware, the solution to equation (1) may be found in real-time, enabling interactive applications such as feedback to the subject or production crew.

The absolute LED positions relative to the headband prior to each performance may be measured. Due to the near proximity of the LEDs, lighting directions and intensity may vary for each pixel.

FIG. 9 illustrates an example of smoothed template geometry that may be used to initialize relative lighting directions and depth. The template geometry may be based on a scanned facial shape of a specific person, a face that blends between multiple subjects, or face geometry modeled by an artist. The template face mesh can be used to estimate the direction and intensity of the lighting. This takes advantage of the fact that the subject's face is fixed relative to the lighting apparatus and that the geometry will remain generally face shaped.

Surface normals are also an indirect measurement of the depth gradient—the change in depth between adjacent pixels. By accumulating these depth gradients from multiple pixels, depth gradients can be integrated across the face to recover a depth map. Depth values can be converted into the three-dimensional location of each pixel and triangulated to form a solid three-dimensional geometric representation of the face.

Most normal integration methods assume an orthographic or distant camera, where the depth gradients (Gx; Gy) may be given by the following equation:

$${G}_{x} = \frac{{N}_{x}}{{N}_{z}} \\ {G}_{y} = \frac{{N}_{y}}{{N}_{z}} \qquad ( 2 )$$

However, the head-mounted camera 101 may have a wide field of view so camera rays may not be parallel. If gradients are computed using Equation (2), the integrated geometry may exhibit fisheye distortion where objects closer to the camera are too large relative to those further way. This effect can be reduced by calibrating camera intrinsics and computing gradients relative to the diverging camera rays. For a given pixel (i; j), the new depth gradients may be re a function of neighboring surface normals (N), ray directions (R) and the distance of each pixel from the camera (D).

$${G}_{x} = {D}_{i + 1 , j} ( 1 - \frac{{R}_{i + 1 , j} \cdot {N}_{i + 1 , j}}{{R}_{i , j} \cdot {N}_{i + 1 , j}} ) - {D}_{i , j} ( 1 - \frac{{R}_{i , j} \cdot {N}_{i , j}}{{R}_{i , j} \cdot {N}_{i + 1 , j}} ) \\ {G}_{y} = {D}_{i , j + 1} ( 1 - \frac{{R}_{i , j + 1} \cdot {N}_{i , j + 1}}{{R}_{i , j} \cdot {N}_{i , j + 1}} ) - {D}_{i , j} ( 1 - \frac{{R}_{i , j} \cdot {N}_{i , j}}{{R}_{i , j} \cdot {N}_{i , j + 1}} ) \qquad ( 3 )$$

The smoothed template geometry may be reused to initialize the per-pixel depth (D). The corresponding integrated geometry may exhibit high-frequency detail from the surface normals and low-frequency shape from the template mesh. To generate more accurate geometry, the lighting directions may be updated and depth gradient estimates based on the integrated geometry, then iterate both the photometric stereo and normal integration stages.

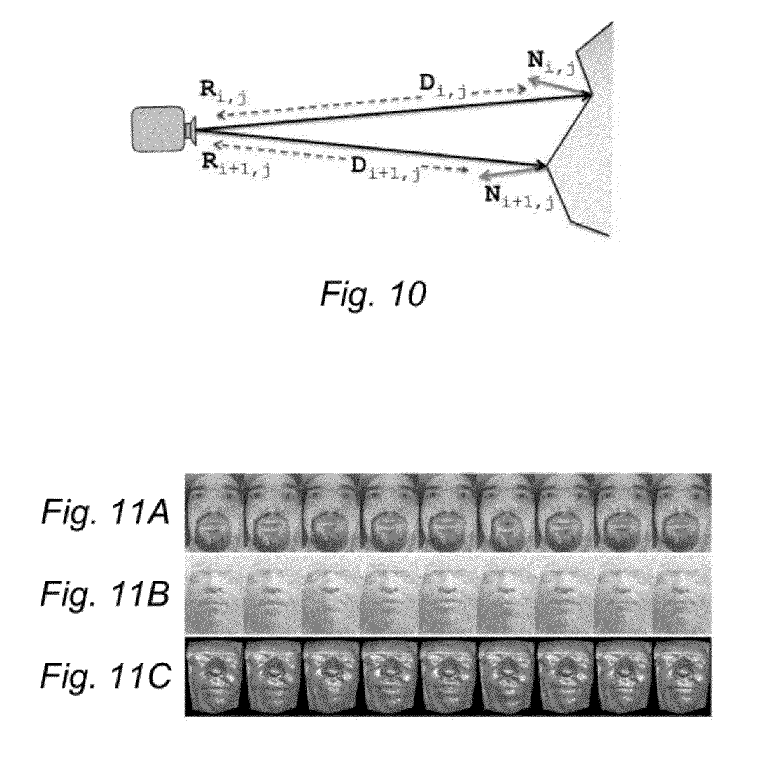

FIG. 10 illustrates an example of multiple light pathways from the face to the camera. The rays of light entering the camera are not parallel and see the face from different directions. The illustration labels two adjacent rays with indices (i, j) and (i+1, j) and labels the corresponding surfaces normal (N), ray directions (R), and camera distances (D).

An iterative approach to fixing low-frequency geometric distortion is related to a larger class of techniques that combine information from surface normals and 3D geometry. The approach may explicitly handle camera field of view and may easily be adapted for real-time applications. More accurate results can be achieved by animating the template mesh or by capturing low-frequency geometry using other multiple views of the face. Multiple cameras or mirrors mounted on the helmet can be used for stereo matching or to triangulate motion capture markers. The resulting sparse geometry could then be used instead of the generic face template to initialize lighting directions and depth gradients.

FIGS. 11A-C illustrate sample results from the data processing system 111 for a dynamic facial sequence using three illumination directions. FIG. 11A illustrates surface albedo texture recovered using photometric stereo; FIG. 10B illustrates surface normals with XYZ direction encoded as RGB color; and FIG. 11C illustrates the integrated surface geometry. The recovered texture and geometry captures both small changes such as mouth and eye contours, as well as the general shape of the face.

Several performances were captured using point light source and gradients and recovered surface normals, albedo texture, and integrated geometry. FIGS. 11A-C illustrate sample sequences of captured images under point-light source illumination from different directions as the subject recited the line “The Five Wizards Jumped Quickly”. The system was able to capture the fast mouth motion associated with the different visemes as well as subtle eyes motion and nose twitches.

Most motion capture systems may be sensitive only to specific infrared bands, so there may be minimal interference between the head-mounted LEDs and the motion capture system. Photometric stereo is a natural addition to existing commercial head-cameras that already incorporate LED illumination. Given simultaneous high resolution facial data body markers, interesting correlations between facial and body motions may be identified and studied.

In general, the reduced separation between gradient lighting patterns (shown in FIGS. 8A and 8B) resulted in higher levels of noise in the surface normals. As shadowed regions were relatively small, the point light sources produced the best results. In FIGS. 11A-C shadow artifacts can be seen as white albedo around the nostril and as a flattening of normals and geometry. These errors may be eliminated by explicitly detecting shadows and updating the integration constraints as in C. H. Esteban, G. Vogiatzis, and R. Cipolla. Overcoming shadows in 3-source photometric stereo. IEEE Transactions on Pattern Analysis and Machine Intelligence, 33, 2011.

The 3D shape information provided by the head-mounted camera opens multiple possibilities for driving a facial rig. Techniques designed to work with structured-light data or depth cameras, such as are described in T. Weise, S. Bouaziz, H. Li, and M. Pauly. Realtime performance-based facial animation. ACM Transactions on Graphics, 30(4), July 2011, may be adapted to use depth from integrated surface normals. Alternatively, surface normals could be used directly as an additional channel of information in an active appearance model.

The images that are generated by the data processing system 111 may be used by a photometric shape-driven animation system 115 to generate realistic 3D animation. A modified version of an Active Appearance Model (AM) may be used as the core of a video-driven facial animation technique. The major difference between this algorithm and the original AAM may be: 1) a convex linear combination may be used and 2) PCA may not be applied on training data (since direct blendshape weights may be preferred, not PCA weights). The following equation may describe the optimization for the blendshape weights:

$${arg min}_{1 \geq {w}_{i} \geq 0 , {\sum }_{i = 1}^{{n}_{b}} {w}_{i} = 1} {‖ {\sum }_{i = 1}^{{n}_{b}} {w}_{i} {W}_{{s}_{i} , q} ( {l}_{i} ) - {W}_{{\sum }_{i = 1}^{{n}_{b}} {w}_{i} {s}_{i} , q} ( T ) ‖}^{2} .$$

where N_{b} is the number of blendshapes, wᵢ is the weight for blendshape i, and sᵢ is the user-defined contour in a given training image Iᵢ that maps to blendshape i. S, may be various mouth shapes in the training images. Q is a common contour space and the function of W_{s,q} defines the warp between source contour s and common contour q. T is an input video frames for which the blendshape weights may be solved. Once the blendshape weights are solved, a box filter may be applied to make the weights temporally smoothed.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, the data processing system 111 could use spatially varying illumination patterns generated by a video projector or another light source to recover three-dimensional facial shape without photometric stereo.

The lighting system 105 may display a constant, spatially varying illumination pattern or multiple sequential patterns. Spatially varying illumination patterns on the face generate additional texture features that can be used to find more accurate stereo correspondence between views of the face (from additional cameras or mirrors), or between the projector pixels and a single camera. These corresponding pixels can be triangulated to recover three dimensional geometry of the face.

The lighting system 105 may also adapt the illumination to the shape and position of face. For example, the data processing system 111 could identify actual eye positions the photographed images of the face. Based on this information a video projector light source could specifically mask out pixels illuminating the subject's eyes. As these pixels are black, the subject would not see or be distracted by the active illumination on her face. Alternatively, the patterns could be illumination patterns could be optimized to focus on particular areas of interest that are changing or are important for the animation.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A photometric facial performance capture system comprising:
a camera configured to capture a sequence of images of a real face that is part of a head of a person while the face changes;
a camera support configured to cause the field of view of the camera to remain substantially fixed with respect to the face, notwithstanding movement of the head;
a lighting system configured to light the face from multiple directions;
a lighting system support configured to cause each of the directions of the light from the lighting system to remain substantially fixed with respect to the face, notwithstanding movement of the head; and
a data processing system configured to compute sequential images of the face as it changes based on the captured images, each computed image including per-pixel surface normals of the face that are calculated based on multiple, separate images of the face, each separate image being representative of the face being lit by the lighting system from a different one of the separate directions.

2. The photometric facial performance capture system of claim 1 further comprising a light controller configured to cause the lighting system to sequentially light the face from each of the multiple directions.

3. The photometric facial performance capture system of claim 2 wherein the camera is configured to capture the captured images at capture moments and wherein the light controller is configured to cause the sequential changes in the lighting system to be synchronized with the capture moments.

4. The photometric facial performance capture system of claim 2 wherein the per-pixel surface normals of each of the computed images are based on a multiplicity of the captured images.

5. The photometric facial performance capture system of claim 4 wherein the per-pixel surface normals of each of the computed images are based on at least three sequential captured images.

6. The photometric facial performance capture system of claim 5 wherein the per-pixel surface normals of each of the computed images are based on at least four sequential captured images.

7. The photometric facial performance capture system of claim 5 wherein one of each of the at least three sequential captured images is captured when the face is not lit by the lighting system.

8. The photometric facial performance capture system of claim 7 wherein the data processing system is configured to compensate for lighting of the face by sources other than the lighting system based on the images that are captured by the camera when the face is not lit by the lighting system.

9. The photometric facial performance capture system of claim 4 wherein the data processing system is configured to compensate for changes in the face that take place between at least two of the multiplicity of captured images when determining the per-pixel surface normals for each of the computed images.

10. The photometric facial performance capture system of claim 2 wherein the light controller is configured to cause the lighting system to sequentially light the face from each of the multiple directions at a rate that is an integer-greater-than-one multiple of the rate at which the camera captures the sequence of images of the face.

11. The photometric facial performance capture system of claim 1 wherein the lighting system is configured to light the face from each of the multiple directions with only a single light source.

12. The photometric facial performance capture system of claim 1 wherein the lighting system is configured to light the face from each of the multiple directions with multiple, spaced-apart light sources.

13. The photometric facial performance capture system of claim 1 wherein:
the lighting system is configured to simultaneously light the face from each of the multiple directions with light of a different color; and
each of the separate images on which the per-pixel surface normals of each of the computed images are based is a version of one of the captured images filtered by a different one of the different colors.

14. The photometric facial performance capture system of claim 1 wherein the lighting system is configured to light the face from the multiple directions with infrared light.

15. The photometric facial performance capture system of claim 1 wherein the lighting system includes a video projector configured to light the face with spatially varying light.

16. The photometric facial performance capture system of claim 1 wherein:
the lighting system is configured to light the face from the multiple directions with polarized light; and
further comprising a polarizer configured to polarize the images captured by the camera with a polarization that filters specularly reflected light.

17. The photometric facial performance capture system of claim 1 further comprising a mirror configured to direct the sequence of image of the real face while it changes to the field of view of the camera.

18. The photometric facial performance capture system of claim 1 wherein the camera, the camera support, the lighting system, and the lighting system support are part of an apparatus configured to mount on the head.

19. A photometric facial performance capture system comprising:
a camera configured to capture a sequence of images of a real face while the face changes;
a lighting system configured to light the face; and
a data processing system configured to compute sequential images of the face as it changes based on the captured images, each computed image being composed of at least per-pixel surface normals of the face that are calculated based on a multiplicity of the captured images, at least one of which is captured while the face is lit by the lighting system and at least one of which is captured while the face is not lit by the lighting system.

20. A facial animation generation system for generating facial animation comprising:
a photometric facial performance capture system configured to capture a sequence of images of a real face while the face changes and to compute images of the face as it changes based on the captured images, each computed image being composed of per-pixel surface normals of the face; and
a photometric shape driven animation system configured to generate a facial animation based on the data, including the per-pixel surface normals.

21. A photometric facial performance capture system comprising:
a camera configured to capture a sequence of images of a real face that is part of a head of a person while the face changes;
a camera support configured to cause the field of view of the camera to remain substantially fixed with respect to the face, notwithstanding movement of the head;
a lighting system configured to light the face;
a lighting system support configured to cause the direction of light from the lighting system to remain substantially fixed with respect to the face, notwithstanding movement of the head; and
a data processing system configured to compute sequential images of the face as it changes based on the captured images, each computed sequential image of the face being computed based on at least one image of the fact that is captured while the face is lit by the lighting system and at least one image of the face that is captured while the face is not lit by the lighting system.
